(19) United States
(12) Patent Application Publication
(10) Pub. No.: US 2026/0339043 A1
(43) Pub. Date: Oct. 29, 2026

(54) FIBER OPTIC CONNECTOR

(71) Applicant: Gloriole Electroptic Technology Corp., Kaohsiung City (TW)

(72) Inventors: Yen-Chang LEE, Kaohsiung City (TW); Kuan-Zhong LIU, Kaohsiung City (TW); Jim LIN, Kaohsiung City (TW)

(21) Appl. No.: 19/400,060

(22) Filed: Nov. 25, 2025

(30) Foreign Application Priority Data
Apr. 23, 2025 (TW) 114204044

(51) Int. Cl. G02B 6/38

(52) U.S. Cl. CPC G02B 6/3893; G02B 6/387

(57) ABSTRACT

A fiber optic connector is adapted to accommodate a fiber ferrule and includes a main shell body, an outer shell, a crimp sleeve, and a boot. The main shell body accommodates the fiber ferrule. The outer shell is slidingly sleeved onto the main shell body, and has two engagement slots. The boot includes a sleeve body portion that is partially inserted into the outer shell, and two tenon portions. The boot is movable rearwardly by manual operation so as to bring the outer shell to move rearwardly relative to the main shell body, and the boot is rotatable by manual operation relative to the outer shell and the crimp sleeve so that the tenon portions are pressed, deformed and are respectively disengaged from the engagement slots, thereby allowing the boot to be separated form the outer shell.

### CROSS-REFERENCE TO RELATED APPLICATION

This application claims priority to Taiwanese Utility Model patent application No. 114204044, filed on Apr. 23, 2025, the entire disclosure of which is incorporated by reference herein.

### FIELD

The disclosure relates to a fiber optic device, and more particularly to a fiber optic connector.

### BACKGROUND

Referring to FIG. 1, a conventional multi-fiber push on (MPO) fiber optic connector 1 includes a fiber ferrule 11, a main shell body 12, a securing sleeve 13, and a boot end 14. The main shell body 12 surrounds the fiber ferrule 11. The securing sleeve 13 is configured to be sleeved on the main shell body 12 from a front-rear direction. The boot end 14 is partially sleeved over and connected to the main shell body 12. The main shell body 12 has a side wall portion 121, and two protruding ribs 122 respectively disposed on two opposite sides of the side wall portion 121 (only one is shown in FIG. 1). Each of the protruding ribs 122 has an inclined outer surface 123 that is inclined in the front-rear direction. A fiber optic adapter 2 is configured to be coupled to the conventional MPO fiber optic connector 1. The fiber optic adapter 2 includes a main body 21 that defines an insertion slot 211, and two hook couplers 22 that each protrude from the main body 21. When the conventional MPO fiber optic connector 1 is coupled to the fiber optic adapter 2 via insertion in the front-rear direction, the fiber ferrule 11 and the main shell body 12 will gradually enter the insertion slot 211 of the main body 21 of the fiber optic adapter 2. At this stage, the inclined outer surface 123 of each of the protruding ribs 122 will force the hook couplers 22 to deform and expand outwards and push the securing sleeve 13 to move rearwards, after the hook couplers 22 have respectively passed over the protruding ribs 122, the hook couplers 22 will respectively be hooked onto the protruding ribs 122. At this stage, the hook couplers 22 will no longer be deformed and will no longer push the securing sleeve 13, and a spring in the securing sleeve 13 will bias the securing sleeve 13 to return to its former position and surround the hook couplers 22. In this way, the conventional MPO fiber optic connector 1 is coupled to the fiber optic adapter 2.

Because the securing sleeve 13 surrounds the hook couplers 22, even if a user were to pull the boot end 14 backward which will cause the protruding ribs 122 to abut against the hook couplers 22, the hook couplers 22 will be unable to deform due to the securing sleeve 13 surrounding and restraining the hook couplers 22. This prevents the hook couplers 22 from expanding and passing over the protruding ribs 122. In this way, the conventional MPO fiber optic connector 1 is securely coupled to the fiber optic adapter 2, and the coupling therebetween may not be loosened or disengaged when accidentally pulled. When the conventional MPO fiber optic connector 1 is to be decoupled with the fiber optic adapter 2, the user grips the securing sleeve 13, and pushes the securing sleeve 13 relative to the main shell body 12 in the front-rear direction towards the boot end 14, and exposes the hook couplers 22 from being surrounded by the securing sleeve 13. This allows the hook couplers 22 to deform and to pass over the protruding ribs 122, and allows the conventional MPO fiber optic connector 1 to be decoupled from the fiber optic adapter 2.

However, according to current market trends, fiber optic connectors (and fiber optic adapters) are increasingly arranged in a high density format. These trends mean that conventional fiber optic connectors are shrinking in size so as to allow a denser set-up between connectors and adapters. This means that adjacent fiber optic connectors are spaced closer together and it is more difficult for the user to grab or manipulate the securing sleeve 13 of the conventional MPO fiber optic connector 1.

### SUMMARY

Therefore, an object of the disclosure is to provide a fiber optic connector that can alleviate at least one of the drawbacks of the prior art.

According to the disclosure, the fiber optic connector is adapted to accommodate a fiber ferrule. The fiber optic connector includes a main shell body, an outer shell, a crimp sleeve and a boot. The main shell body surrounds and defines an inner space adapted to accommodate the ferrule. The outer shell is configured to be slidingly sleeved onto the main shell body in a front-rear direction, and has two engaging slots that are spaced apart from each other in a height direction which is perpendicular to the front-rear direction and that are formed through the outer shell in the height direction. The crimp sleeve includes an annular wall portion that is sleeved onto the main shell body, and an extension portion that extends rearwardly from the annular wall portion in the front-rear direction. The boot is made of a compressible and elastic material, and includes a sleeve body portion, and two tenon portions. The sleeve body portion is sleeved over the annular wall portion and enveloping the extension portion of the crimp sleeve and is partially inserted into the outer shell. The two tenon portions protrude radially from an outer surface of the sleeve body portion to respectively extend into the engagement slots of the outer shell. The boot is movable rearwardly by manual operation so as to bring the outer shell to move rearwardly relative to the main shell body, and said boot is rotatable by manual operation relative to said outer shell and said crimp sleeve so that said tenon portions are pressed, are deformed and are respectively disengaged from said engagement slots, thereby allowing said boot to be separated from said outer shell.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is an exploded perspective view illustrating a conventional fiber optic connector and a conventional fiber optic adapter.

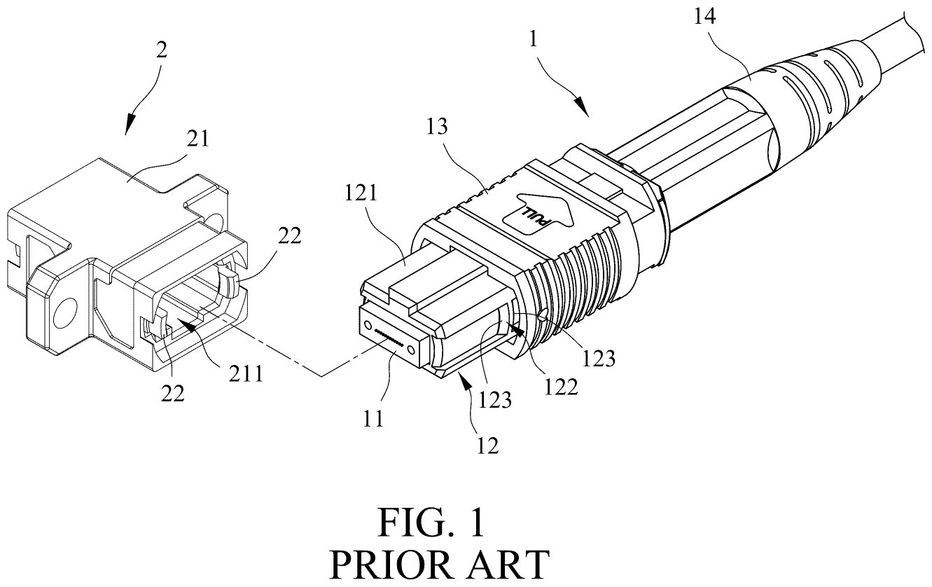

FIG. 2 is an exploded perspective view illustrating a fiber optic connector according to a first embodiment of the present disclosure.

FIG. 3 is a perspective view illustrating the first embodiment in an assembled state.

FIG. 4 is a cross-sectional front view illustrating the first embodiment and two snap hook portions.

FIG. 5 is a cross-sectional side view illustrating one of the two snap hook portions shown in FIG. 4.

FIG. 6 is a cross-sectional side view illustrating the first embodiment.

FIG. 7 is a cross-sectional rear view illustrating the first embodiment.

FIG. 8 is a cross-sectional rear view illustrating the first embodiment.

FIG. 9 is a perspective view illustrating the first embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

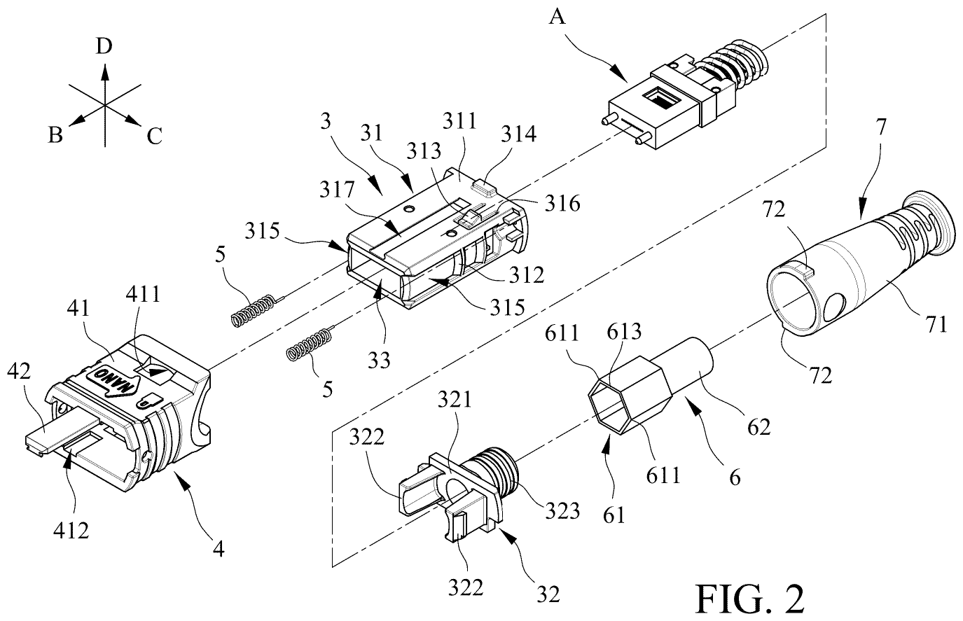

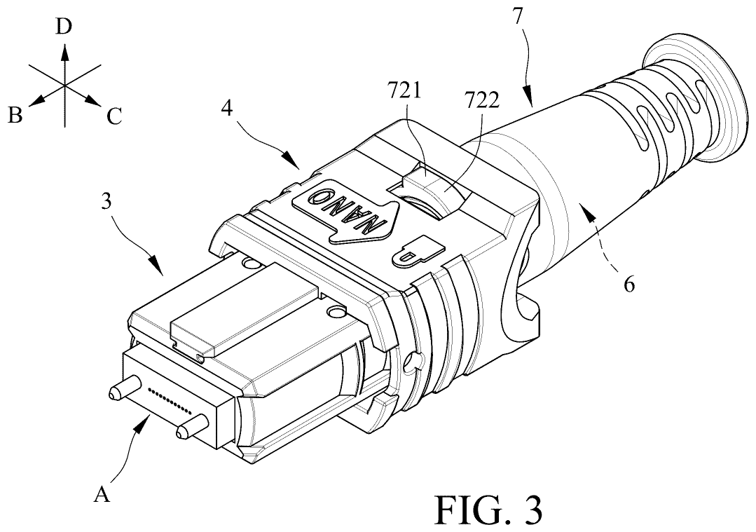

Referring to FIGS. 2 and 3, a first embodiment of a fiber optic connector is adapted to accommodate a fiber ferrule (A). The fiber optic connector includes a main shell body 3, and outer shell 4, two returning springs 5, a crimp sleeve 6, and a boot 7. The main shell body 3 surrounds and defines an inner space 33 and is adapted to accommodate the fiber ferrule (A). The outer shell 4 is configured to be slidingly sleeved onto the main shell body 3 in a front-rear direction (B). The two returning springs 5 are each disposed between the main shell body 3 and the outer shell 4, each extends in the front-rear direction (B), and are spaced apart in a width direction (C) that is perpendicular to the front-rear direction (B). The crimp sleeve 6 is sleeved over a rear end portion of the main shell body 3, and is partially covered by the outer shell (4). The boot 7 is made of a compressible and elastic material such as rubber, and is sleeved over the crimp sleeve 6.

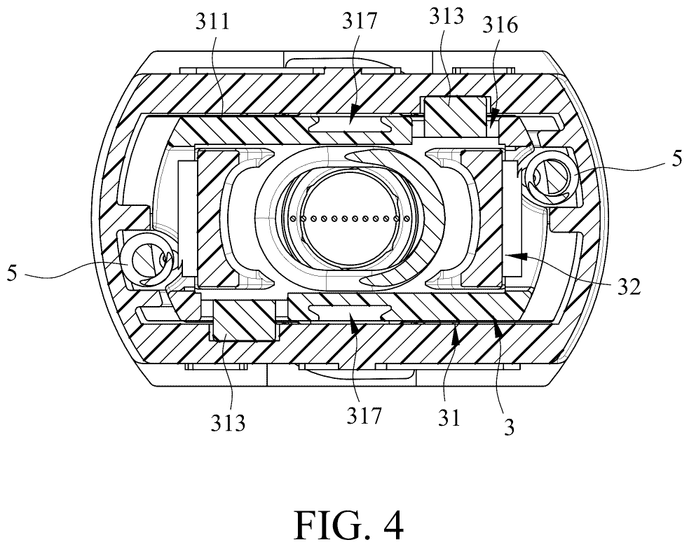

Referring to FIGS. 2, 4 and 5, the main shell body 3 includes a front shell body 31 that surrounds the fiber ferrule (A), and a rear shell body 32 that is connected to a rear end of the front shell body 31 along the front-rear direction (B). The front shell body 31 has a shell wall portion 311, two protruding ribs 312, two snap hook portions 313, two block portions 314, two side grooves 315, two through holes 316, and two key slots 317. The shell wall portion 311 defines the inner space 33 that accommodates the fiber ferule (A). The ribs 312 protrude outwardly from two opposite sides of the shell wall portion 311 in the width direction (C) (only one is shown in FIG. 2 due to the viewing angle). The two snap hook portions 313 protrudes from the shell wall portion 311 in a height direction (D) that is perpendicular to the front-rear direction (B) and the width direction (C), and that are opposite to each other in the height direction (D). The two block portions 314 protrude outwardly and oppositely from the shell wall portion 311 in the height direction (D) (only one is shown in FIG. 2 due to the view angle). The two side grooves 315 are formed opposite to each other on the shell wall portion 311, are spaced apart from each other in the width direction (C), and each extends in the front-rear direction (B). The two through holes 316 are formed through the shell wall portion 311 in the height direction (D), they are spaced apart from each other in the height direction (D), and they spatially interconnect the accommodation space 33. The front shell body 31 has two key slots 317 that are spaced apart from each other in the height direction (D), that extend rearwardly from a front end of an outer surface of the shell wall portion 311 in the front-rear direction (B). The two protruding rib portions 312 are respectively located in the two side grooves 315, and are integrally formed with the shell wall portion 311. The snap hook portions 313 are respectively disposed in the through holes 316. Each of the snap hook portions 313 is bendable relative to the shell wall portion 31, is pressable into a respective one of the through holes 316 by a pressure, and is restorable to protrude form the shell wall portion 311 in the height direction (D) when the pressure is withdrawn. Each of the snap hook portions 313 are slidingly hooked onto an inner surface of the outer shell 4. Furthermore, each of the snap hook portions 313 of the front shell body 31 has a rear end relative to the front-rear direction (B) that is integrally formed and connected with the shell wall portion 311, and a front end relative to the front-rear direction (B) that protrudes in the height direction (D) and has a barb shape.

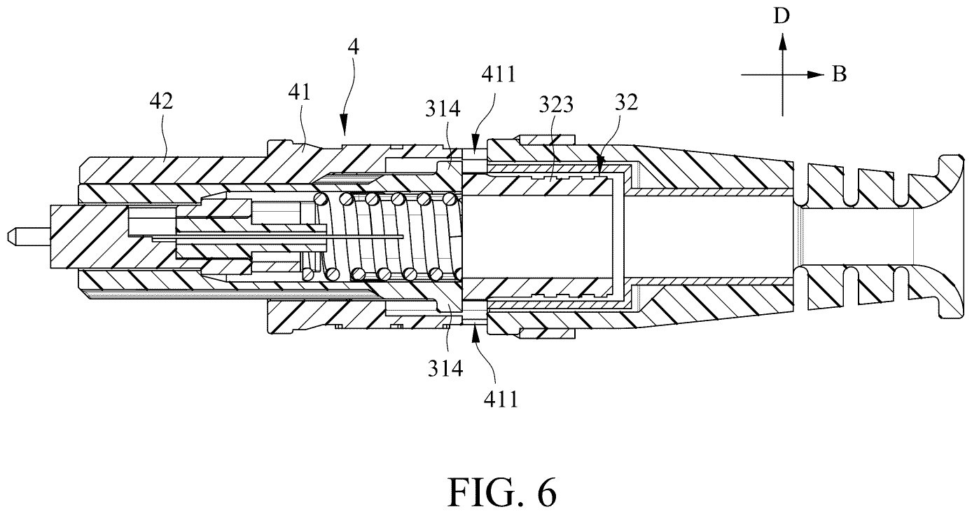

Referring to FIGS. 2, 5 and 6, the rear shell body 32 of the main shell body 3 has a base seat portion 321, two engaging portions 322, and a mounting portion 323. The base seat portion 321 is placed in abutment with a rear edge of the shell wall portion 311 of the front shell body 31 by moving it forwardly in the front-rear direction (B). The two engaging portions 322 each extends from the base seat portion 321 forwardly in the front-rear direction (B), extends into the accommodation space 33, and engages an inner surface of the shell wall portion 311 of the front shell body 31. The mounting portion 323 protrudes rearwardly form the base seat portion 321 in the front-rear direction (B). The two block portion 314 are used as a rear limiter to limit the outer shell 4 from moving rearwardly relative to the front shell body 31 along the front-rear direction (B). The outer shell 4 has two engagement slots 411 that are spaced apart from each other in the height direction (D), and that are formed through the outer shell 4 in the height direction (D). In particular, the outer shell 4 further has a surrounding wall portion 41, and a key portion 42. The surrounding wall portion 41 is sleeved over the shell wall portion 311 of the front shell body 31 of the main shell body 3, and has two retention grooves 412 that extend rearwardly from a front end of an inner surface of the surrounding wall portion 41, that are spaced apart from each other in the height direction (D), and that are configured to respectively allow the snap hook portions 313 of the front shell body 31 to slide in the front-rear direction (B). The engagement slots 411 of the outer shell 4 are formed through the surrounding wall portion 41 along the height direction (D). The key portion 42 is configured to slidingly engage one of the two key slots 317 in the front-rear direction (B) in such a manner that a portion of the key portion 42 remains exposed from the key slot 317. Each of the two returning springs 5 have two opposite ends that respectively abut against the shell wall portion 311 of the front shell body 31 of the main shell body 3 and the surrounding wall portion 41 of the outer shell 4, and biases the outer shell to move forward in the front-rear direction (B).

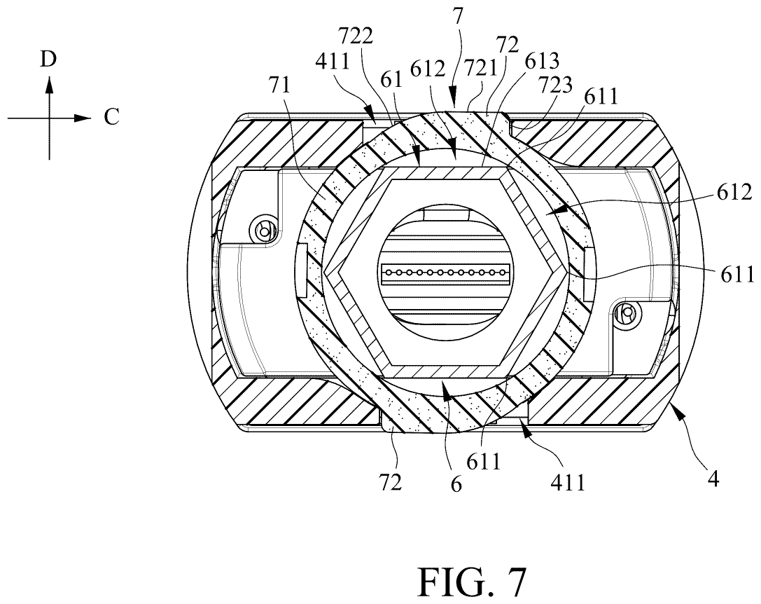

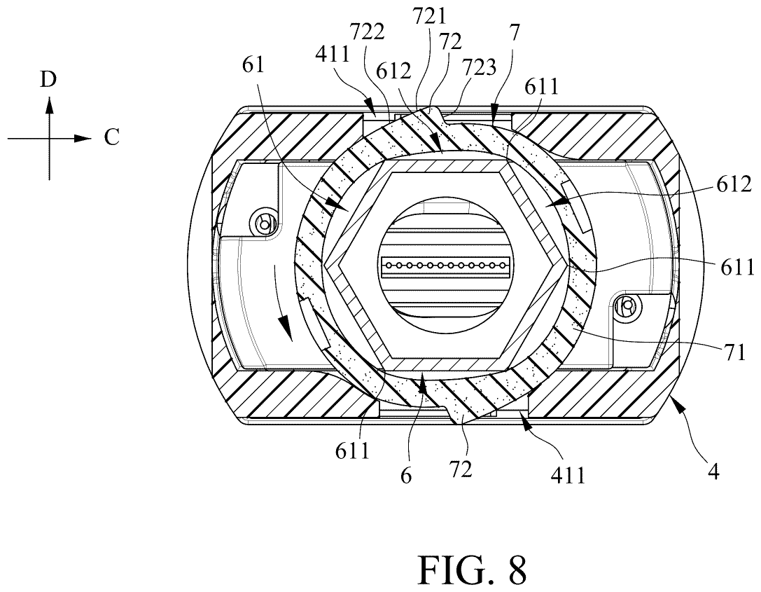

Referring to FIGS. 2, 7 and 8, the crimp sleeve 6 includes an annul ar wall portion 61, and an extension portion 62. The annular wall portion 61 is sleeved onto and secured to the mounting portion 323 of the rear shell body 32 of the main shell body 3. The extension portion 62 extends rearwardly from the annular wall portion 61 in the front-rear direction (B). In this embodiment, the annular wall portion 61 is a polygonal tube, particularly a hexagonal tube as an example; however, the annular wall portion 61 is not limited to this particular manifestation. The annular wall portion 61 has a plurality of supporting portions 611 (i.e., six corners of the hexagonal tube) that are angularly spaced apart from each other around a central axis of the annular wall portion 61, and a plurality of indenting portions 613 (i.e., six sides of the hexagonal tube) alternating with the supporting portions 611. The boot 7 includes a sleeve body portion 71, and two tenon portions 72. The sleeve body portion 71 is sleeved over the annular wall portion 61 and enveloping the extension portion 62 of the crimp sleeve 6, and is partially inserted into the outer wall 4. The two tenon portions 72 protrude radially from an outer surface of the sleeve body portion 72 to respectively extend into the engagement slots 411 of the outer shell 4. The sleeve body portion 71 of the boot 7 has an inner sleeve surface. Each of the supporting portions 611 of the annular wall portion 61 abuts against the inner sleeve surface of the sleeve body portion 71 of the boot 7. The indenting portions 613 are spaced apart from the inner sleeve surface of the sleeve body portion 71 so that a plurality of clearances 612 are formed between the indenting portions 613 and the inner sleeve surface. More specifically, in this embodiment, the clearances 612 are the spaces between the indenting portions 613 and the inner sleeve surface of the sleeve body portion 71. The boot 7 is movable rearwardly by manual operation so as to bring the outer shell 4 to move rearwardly relative to the main shell body 3, and the boot 7 is also rotatable by manual operation so that the tenon portions 72 are rotated relative to the outer shell 4 and the crimp sleeve 6, pressed and deformed between the outer shell 4 and the crimp sleeve 6, and are respectively disengaged form the engagement slots 411, thereby allowing the boot 7 to be separated from the outer shell 4. More specifically, when the boot 7 is rotated relative to the outer shell 4 to cause each of the tenon portions 72 to move form a respective one of the engagement slots 411 into the inner sleeve surface of the outer shell 4, each of the tenon portions 72 is deformable and compressible by a pressure exerted by the inner sleeve surface (due to a reaction force), and when each of the tenon portions 72 reaches one of the clearances 612, each of the tenon portions 72 is compressed toward the one of the clearances 612 and is able to move away from the respective one of the engagement slots 411. Continued rotation of the boot 7 in the same direction will cause each of the tenon portions 72 to move into the other one of the engagement slots 411. It should be noted that the tenon portions 72 are restorable to the original shapes and thickness thereof when no pressure is exerted thereon.

More specifically, in this embodiment, each of the tenon portions 72 of the boot 7 protrudes radially and outwardly from a front end portion of the outer surface of the sleeve body portion 71, and has a radially thick portion 721, a sloping portion 722 slopingly extending in an angular direction from the radially thick portion 721 to the outer surface of the sleeve body portion 71, and a steep face 723 formed on a side of the radially thick portion 721 that is opposite to the sloping portion 722 in the angular direction. In this embodiment, the boot 7 is rotatable only in a first rotating direction. When each of the tenon portions 72 is moved in the first rotating direction from a respective one of the engagement slots 411 into the inner sleeve surface of the outer shell 4, the sloping portion 722 is moved into and compressed by the inner sleeve surface prior to the radially thick portion 721. When the tenon portions 72 respectively extend into the engagement slots 411, the steep faces 723 of the tenon portions 72 respectively engage with boundaries of the engagement slots 411 to prevent the boot 7 from rotating in a second direction opposite to the first rotating direction. In other words, the user may rotate the boot 7 and the tenon portions 72 only in the first direction to install or remove the boot 7. This design facilitates assembly, replacement and maintenance. Furthermore the uni-directional rotation of the boot for assembly and disassembly is a fool-proof design that aids user assembly. Furthermore, when each tenon 72 moves past one of the clearances 612 located close to a respective one of the engagement slot 411 and hence moves out or into the respective engagement slot 411, a sudden resiliently deforming motion of each tenon portion 72 can provide haptic feedback, allowing the user to recognize that the tenon portions 72 have rotated to their correct positions without visual confirmation.

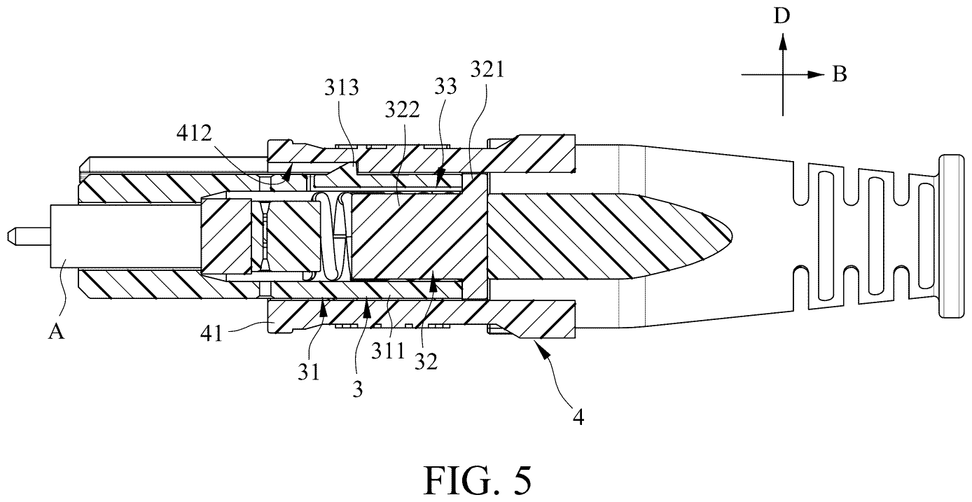

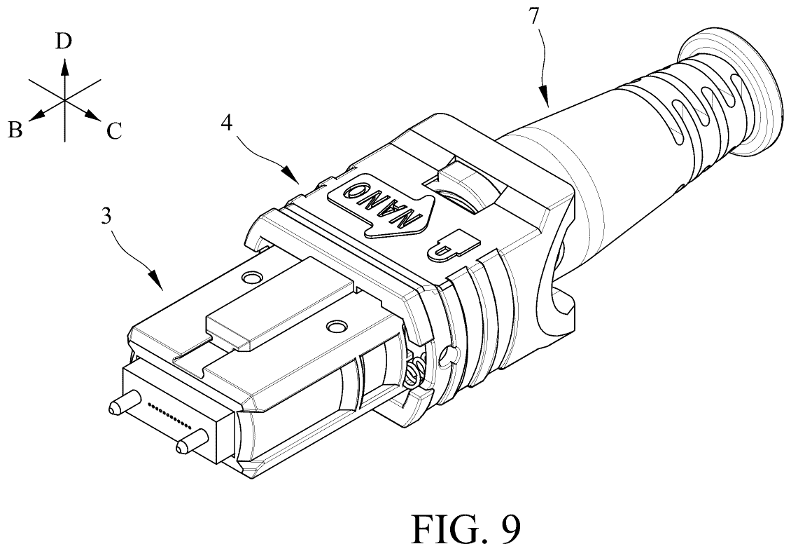

Referring to FIGS. 2, 3 and 9, the user may pull the boot 7 along the front-rear direction (B) backwards to bring the outer shell 4 to move backwards. In this state, the fiber optic connector may be unplugged from a fiber optic adapter by applying additional force in the front-rear direction (B). This configuration allows fiber optic connectors and adapters to be paired together in a very dense arrangement without affecting user operation. Furthermore, referring to FIGS. 2, 5 and 6, when the fiber optic connector is not plugged into a fiber optic adapter, the user may pull the outer shell 4 forwardly along the front-rear direction (B). When the user's pulling force exceeds a preset force, the snap hook portions 313 will be respectively pressed into the through holes 316 by the pressure exerted by the inner surface of the outer shell 4, (see FIG. 5, 313 is bendable downward or inward to extend into 316, the preset force is related to bendability or stiffness of 313), thereby allowing the outer shell 4 to be detached from the shell wall portion 311 of the main shell body 3. The snap hook portions 313 is restorable to protrude form the shell wall portion 311 in the height direction (D) when no pressure is exerted thereon. When the outer shell 4 is to be sleeved back onto the main shell body 3, the outer shell 4 is moved backward along the front-rear direction (B) until the snap hook portions 313 are slidingly hooked onto the retention grooves 412 of the surrounding wall portion 41 of the outer shell 4. If the user needs to change the polarity of the fiber optic connector, the key portion 42 of the outer shell 4 that is engaged to one of the two key slots 317 may be disengaged and then re-engaged with the other one of the two key slots 317. This design makes simplifies the changing of the polarity of the fiber optic connector. It should be noted that in some embodiments, the two through holes 316 of the front shell body 31 may be omitted, and the snap hook portions 313 may be formed directly on the shell wall portion 311, and protrude from the shell wall portion 313 upwardly in the height direction (D). In this case, the outer shell 4 is designed to be slightly deformable to allow the snap hook portions 313 to be unhooked from the inner surface of the outer shell 4.

In summary of the above, the fiber optic connector according to the present disclosure is operated by pulling the boot 7 at the rear of the device instead of grabbing or pinching the outer shell 4. In this way, the fiber optic connector of the present disclosure may be arranged more densely without affecting operations. Additionally, the user may rotate the boot 7 in the first rotating direction, and the tenon portions 72 that are deformable and compressible can be deformed by the pressure of the outer shell 4 to move from the respective engagement slots 411 into the inner sleeve surface of the outer shell 4 and thus allows the boot 7 to be separated from the outer shell 4. In this way, the boot 7 may be separated form the outer shell 4 and unsleeved from the crimp sleeve 6, which simplifies maintenance and assembly of the fiber optic connector.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A fiber optic connector adapted to accommodate a fiber ferrule, said fiber optic connector comprising:
a main shell body surrounding and defining an inner space adapted to accommodate the fiber ferrule;
an outer shell configured to be slidingly sleeved onto said main shell body in a front-rear direction, and having two engagement slots that are spaced apart from each other in a height direction which is perpendicular to the front-rear direction and that are formed through said outer shell in the height direction;
a crimp sleeve including an annular wall portion that is sleeved onto said main shell body, and an extension portion that extends rearwardly from the annular wall portion in the front-rear direction; and
a boot made of a compressible and elastic material, and including a sleeve body portion that is sleeved over said annular wall portion and enveloping said extension portion of said crimp sleeve and that is partially inserted into said outer shell, and two tenon portions that protrude radially from an outer surface of said sleeve body portion to respectively extend into said engagement slots of said outer shell; and
wherein said boot is movable rearwardly by manual operation so as to bring said outer shell to move rearwardly relative to said main shell body, and said boot is also rotatable by manual operation so that said tenon portions are rotated relative to said outer shell and said crimp sleeve, pressed and deformed between said outer shell and said crimp sleeve, and respectively disengaged from said engagement slots, thereby allowing said boot to be separated from said outer shell.

2. The fiber optic connector as claimed in claim 1, wherein:
said annular wall portion of said crimp sleeve has a plurality of supporting portions that are angularly spaced apart from each other around a central axis of said annular wall portion, and a plurality of indenting portions alternating with said supporting portions;
said sleeve body portion of said boot having an inner sleeve surface, each of said supporting portions of said annular wall portion abutting against said inner sleeve surface of said sleeve body portion of said boot;
said indenting portions are spaced apart from said inner sleeve surface of said sleeve body portion so that a plurality of clearances are formed between said indenting portions and said inner sleeve surface;
when said boot is rotated relative to said outer shell to cause each of said tenon portions to move from a respective one of said engagement slots into said inner sleeve surface of said outer shell, each of said tenon portions is deformable and compressible under a pressure exerted by said inner sleeve surface, and when each of said tenon portion reaches one of said clearances, each of said tenon portions is compressed toward said one of said clearances and is able to move away from said respective one of said engagement slots;
said tenon portions are restorable to the original shapes and thickness thereof when no pressure is exerted thereon.

3. The fiber optic connector as claimed in claim 2, wherein said annular wall portion is a polygonal tube.

4. The fiber optic connector as claimed in claim 3, wherein:
said main shell body includes a front shell body that surrounds the fiber ferrule, and a rear shell body that is connected to a rear end of the front shell body along the front-rear direction, said annular wall portion of said crimp sleeve being sleeved onto said rear shell body of said main shell body;
said front shell body has a shell wall portion, two protruding ribs that protrude outwardly from two opposite sides of said shell wall portion in a width direction that is perpendicular to the front-rear direction and the height direction, and two side grooves that are formed opposite to each other on said shell wall portion, that are spaced apart from each other in the width direction, and that each extends in the front-rear direction, said two protruding rib portions being respectively located in said two side grooves.

5. The fiber optic connector as claimed in claim 4, wherein:
said front shell body has two snap hook portions that protrudes from said shell wall portion in the height direction and that are opposite to each other in the height direction; and
each of said snap hook portions are slidingly hooked onto an inner surface of said outer shell.

6. The fiber optic connector as claimed in claim 5, wherein:
said front shell body further has two through holes that are formed through said shell wall portion in the height direction, that are spaced apart from each other in the height direction, and that spatially interconnects said accommodation space;
said snap hook portions are respectively disposed in said through holes, each of said snap hook portions is bendable relative to said shell wall portion, is pressable into a respective one of said through holes by a pressure, and is restorable to protrude from said shell wall portion in the height direction when the pressure is withdrawn.

7. The fiber optic connector as claimed in claim 6, wherein:
each of said snap hook portions of said front shell body has a rear end relative to the front-rear direction that is integrally formed and connected with said shell wall portion, and a front end relative to the front-rear direction that protrudes in the height direction and has a barb shape;
said outer shell further having a surrounding wall portion that is sleeved over said shell wall portion of said front shell body of said main shell body and that has said engagement slots, and two retention grooves that extend rearwardly from a front end of an inner surface of said surrounding wall portion, that are spaced apart from each other in the height direction, and that are configured to respectively allow said snap hook portions of said front shell body to slide in the front-rear direction.

8. The fiber optic connector as claimed in claim 4, wherein said main shell body further has two block portions, said two block portions protruding outwardly and oppositely from said shell wall portion in the height direction for use as a rear limiter to limit said outer shell from moving rearwardly relative to said front shell body along the front-rear direction.

9. The fiber optic connector as claimed in claim 4, wherein:
said front shell body has two key slots that are spaced apart from each other in the height direction, that extend rearwardly from a front end of an outer surface of said shell wall portion in the front-rear direction; and
said outer shell further having a surrounding wall portion that is sleeved over said shell wall portion of said front shell body of said main shell body and that has said engagement slots, and a key portion that extends forwardly from a front edge of said surrounding wall portion in the front-rear direction, and that is configured to slidingly engage one of said two key slots in the front-rear direction.

10. The fiber optic connector as claimed in claim 4, wherein:
said rear shell body of said main shell body has a base seat portion that abuts against a rear edge of said shell wall portion of said front shell body, two engaging portions that each extends from said base seat portion forwardly in the front-rear direction, that extends into said accommodation space, and engages an inner surface of said shell wall portion of said front shell body, and a mounting portion that protrudes rearwardly from said base seat portion in the front-rear direction; and said annular wall portion of said crimp sleeve is sleeved on said mounting portion.

11. The fiber optic connector as claimed in claim 1, further comprising two returning springs that are each disposed between said main shell body and said outer shell and that each extends in the front-rear direction, each of said two returning springs having two opposite ends that respectively abut against said main shell body and said outer shell.

12. The fiber optic connector as claimed in claim 2, wherein:
each of said tenon portions of said boot protrudes radially and outwardly from a front end portion of said outer surface of said sleeve body portion, and has a radially thick portion, a sloping portion slopingly extending in an angular direction from said radially thick portion to said outer surface of said sleeve body portion, and a steep face formed on a side of said radially thick portion that is opposite to said sloping portion in the angular direction;
said boot is rotatable only in a first rotating direction, and when each of said tenon portions is moved in said first rotating direction from a respective one of said engagement slots into said inner sleeve surface of said outer shell, said sloping portion is moved into and compressed by said inner sleeve surface prior to said radially thick portion; and
when said tenon portions respectively extend into said engagement slots, said steep faces of said tenon portions respectively engage with boundaries of said engagement slots to prevent said boot from rotating in a second rotating direction opposite to said first rotating direction.
